(19) United States
(12) Patent Application Publication
(10) Pub. No.: US 2023/0038608 A1
(43) Pub. Date: Feb. 9, 2023

(54) PROCESS AND PRODUCTS FOR REMOVAL OF CONTAMINANTS IN LIQUID COMPOSITIONS

(71) Applicant: NuMat Technologies, Inc., Skokie, IL (US)

(72) Inventors: Glenn McPherson Tom, Bethany Beach, DE (US); Natalie Nicholls, Chicago, IL (US); Mitchell Hugh Weston, Chicago, IL (US); Nicolaas Vermeulen, Chicago, IL (US); Vincent Rinaolo, Chicago, IL (US)

(73) Assignee: NuMat Technologies, Inc., Skokie, IL (US)

(21) Appl. No.: 17/867,449

(22) Filed: Jul. 18, 2022

Related U.S. Application Data
(60) Provisional application No. 63/223,418, filed on Jul. 19, 2021.

(51) Int. Cl. B01J 20/26; B01J 20/28; C08F 8/34; B01D 15/08

(52) U.S. Cl. CPC B01J 20/265; B01J 20/28073; B01J 20/28083; B01J 20/28088; C08F 8/34; B01D 15/08

(57) ABSTRACT

Functionalized polymer adsorbents for removing impurities from a feed stream comprising an active pharmaceutical ingredient (API) include particles of functionalized with at least one functional moiety capable of binding one or more contaminants, the polymer being a macroreticular polymer and the functionalized polymer adsorbents having a pore volume of at least 0.65 cm³/g. Alternatively, the adsorbent can comprise a polymer functionalized with either 2,4,6,-dimercaptotriazine-ethylenedithiol (DMT-EDT) adduct, 2,4,6,-trimercaptotriazine-ethylenedithiol (TMT-EDT) adduct, or a combination thereof, and the polymer can be either a macroreticular polymer or a swellable polymer. The adsorbents can be used in either continuous or batch processes for removing contaminants from an API-containing feed stream wherein the contaminants can include elemental impurities, particularly palladium.

### CLAIM OF PRIORITY

This patent application claims priority from U.S. provisional patent application Ser. No. 63/223,418 filed Jul. 19, 2021.

### FIELD

This disclosure generally relates to functionalized polymer adsorbents for use in removing contaminants from liquid compositions, and processes using such adsorbents. More particularly, this disclosure relates to functionalized polymer adsorbents and processes for the removal of contaminants such as elemental impurities from Active Pharmaceutical Ingredient (API) process streams.

### BACKGROUND

In March 2019, the International Council for Harmonization (ICH) of Technical Requirements for Pharmaceuticals for Human Use issued its guidelines for elemental impurities in pharmaceutical products, Q3D(R1). These guidelines dictate the levels of elemental impurities which are allowed in pharmaceutical products. The elements are divided into three classes based on their Permitted Daily Exposure (PDE). Class 1 lists As, Cd, Hg, and Pb metals which are human toxicants and are present in drugs as a result of impurities in chemicals used to manufacture the drugs or active pharmaceutical ingredients (API). Class 2 is divided into class 2A and 2B. Class 2A elements are Co, V, and Ni, while class 2B elements are Ag, Au, Ir, Os, Pd, Pt, Rh, Ru, Se, and Tl. These elements are generally present in API owing to their use in synthesizing APIs. The elements in class 2A have a greater probability of being present in the API versus those in class 2B. Class 3 elements are Ba, Cr, Cu, Li, Mo, Sb, and Sn. Class 3 elements are considered to have lower toxicity than elements in classes 1 or 2.

Most of the elements in class 2 are present because they are used as catalysts in the synthesis of API and thus after the API is synthesized, the elements must be removed from the API process stream so that their concentration is below their PDE. Adsorbents which have been used in the industry to remove elemental impurities use silica, polymers or polymer fibers as a base to which are attached functional groups which can bind to the elements. These functional groups include sulfur or nitrogen containing groups such as mercaptans, amines (both alkyl and aryl), etc. The amount of adsorbent needed to remove a particular impurity can be quite large or it may be necessary to pass the API solution through multiple columns in order to achieve the necessary reduction in elemental impurity concentration.

It also is frequently necessary or desirable to remove elemental impurities and other contaminants from liquid compositions other than API process streams.

### SUMMARY OF THE DISCLOSURE

In order to meet this need, in one aspect Applicants have developed adsorbents comprising particles of macroreticular polymer functionalized with at least one functional moiety capable of binding one or more contaminants, the adsorbent particles having a pore volume of at least 0.65 cm³/g.

In one embodiment the functionalized macroreticular polymer adsorbent particles have a pore volume of at least 0.65 cm³/g and an average particle size of less than 150 microns.

In one embodiment the adsorbent particles have a particle size distribution D90 ranging from about 50-150 microns.

In one embodiment, the adsorbent particles have a pore volume of at least 0.65 cm³/g and a BET surface area of greater than 300 m²/g.

In one embodiment, the adsorbent particles have a pore volume of at least 0.65 cm³/g and a pore size distribution wherein D50 is less than 200 Å.

In one embodiment, the at least one functional moiety is a compound selected from cysteamine, 2,4,6,-trimercaptotriazine (TMT), 2,4,6,-dimercaptotriazine (DMT), 2,4,6,-dimercaptotriazine-ethanedithiol (DMT-EDT) adduct, 2,4,6,-trimercaptotriazine-ethanedithiol (TMT-EDT) adduct, thioglycolic acid (TGA), thiourea, 4-mercapto pyridine, 1,4,7,10-Tetraazacyclododecane-1,4,7,10-tetraacetic acid (DOTA), ethylenediaminetetraacetic acid (EDTA), thiosulfate (TS), mercaptomethyl phosphonic acid (MPA), trimercaptotriazine-methyl-phosphonic acid (TMT-PA), and mixtures of any of the foregoing.

In one embodiment, the at least one functional moiety is selected from cysteamine, 2,4,6,-trimercaptotriazine (TMT), 2,4,6,-dimercaptotriazine (DMT), 2,4,6,-dimercaptotriazine-ethanedithiol (DMT-EDT) adduct, 2,4,6,-trimercaptotriazine-ethanedithiol (TMT-EDT) adduct, and mixtures of any of the foregoing.

In one embodiment the at least one functional moiety is selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing.

In one aspect, Applicants have developed adsorbents comprising particles of polymer functionalized with at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing. In one embodiment the polymer is a swellable polymer. In one embodiment the polymer is a macroreticular polymer. In one embodiment the adsorbent particles based on macroreticular polymer and having at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing have a pore volume of at least 0.65 cm³/g. In one embodiment the particles have a pore volume of at least 0.65 cm³/g and an average particle size in the range of about 50-300 microns, or in the range of 125-250 microns, or less than 150 microns.

Also disclosed herein is a synthetic method of functionalizing a polymer comprising alkene groups, said method comprising the steps of
a.) reacting said polymer with a first reactant comprising a thiol group and a linking group, whereby a first reactant thiol group reacts with a polymer alkene group to form a first intermediate having a thioether linkage between said polymer and said linking group,
b.) reacting said first intermediate with a second reactant comprising an aryl or heteroaryl group, wherein said aryl group or heteroaryl group is substituted or unsubstituted, to form a second intermediate having said substituted or unsubstituted aryl or heteroaryl group bound directly or indirectly to the linking group, and
c.) reacting said second intermediate with a third reactant to convert said bound substituted or unsubstituted aryl or heteroaryl group to a functional moiety, thereby functionalizing said polymer with said functional moiety.

In one embodiment of the synthetic method, the functional moiety is capable of binding one or more contaminants.

In one embodiment of the synthetic method, the functional moiety contains at least one thiol group, at least one thio group, or a combination thereof.

In one embodiment of the synthetic method, the second reactant comprises a heteroaryl group.

In one embodiment of the synthetic method, the second reactant comprises a heteroaryl group which is a substituted triazine group.

Also disclosed herein is a process for reducing the concentration of at least one contaminant in a liquid composition, the process comprising contacting said liquid composition with an adsorbent at purification conditions to adsorb at least a portion of the at least one contaminant; wherein the adsorbent comprises particles of polymer functionalized with at least one functional moiety capable of binding one or more contaminants, the polymer being a macroreticular polymer, the functionalized polymer adsorbent having a pore volume of at least 0.65 cm³/g.

Also disclosed herein is a process for reducing the concentration of at least one contaminant in a liquid composition, the process comprising contacting said liquid composition with an adsorbent at purification conditions to adsorb at least a portion of the at least one contaminant; wherein the adsorbent comprises particles of polymer functionalized with at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing. In one embodiment of this process the polymer is a swellable polymer. In one embodiment of this process the polymer is a macroreticular polymer. In one embodiment of this process the polymer is a macroreticular polymer and the functionalized polymer adsorbent has a pore volume of at least 0.65 cm³/g. In one embodiment of the process the adsorbent particles having at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing have an average particle size in the range of about 100-300 microns, or in the range of 125-250 microns. In one embodiment of the process the adsorbent particles having at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing have an average particle size of less than 150 microns

In various embodiments the process of reducing the concentration of a contaminant can be accomplished with any of the adsorbents as disclosed herein.

The process step of contacting the liquid composition with the adsorbent as described herein can be either a batch process or a continuous process.

In one embodiment of the process the liquid composition further comprises an active pharmaceutical ingredient or a precursor thereof.

In one embodiment of the process the liquid composition is a composition in the process for the manufacture of an active pharmaceutical ingredient.

In one embodiment of the process the liquid composition is a composition in the process for the manufacture of an active pharmaceutical ingredient and the composition further comprises an active pharmaceutical ingredient or a precursor thereof.

In one embodiment of the process said at least one contaminant is an elemental impurity selected from at least one element from class 1, class 2 Å, class 2B, and class 3 of the ICH Q3D(R1) guidelines.

In one embodiment of the process the adsorbent binds a quantity of the elemental impurity in the liquid composition to provide a liquid composition having a concentration of the elemental impurity which calculates to a concentration of the elemental impurity in a recovered API which is at or below its Permitted Daily Exposure (PDE).

These and other aspects and embodiments will become clearer upon review of the following detailed description.

### DESCRIPTION OF THE FIGURES

FIG. 1 presents isotherm data for two of the adsorbents of Example 1 after sizing to a desired particle size compared to two commercially available adsorbents.

FIG. 2A illustrates the incremental pore size distribution of three adsorbents of Example 1 prior to particle size reduction compared to two commercially available adsorbents, measured as incremental pore volume as a function of pore width.

FIG. 2B illustrates the incremental pore size distribution of three adsorbents of Example 1 prior to particle size reduction, compared to the polymer from which they were made, measured as incremental pore volume as a function of pore width.

FIG. 2C illustrates the cumulative pore size distribution of three adsorbents of Example 1 prior to particle size reduction compared to two commercially available adsorbents, measured as cumulative pore volume as a function of pore width.

FIG. 2D illustrates the cumulative pore size distribution of three adsorbents of Example 1 prior to particle size reduction, compared to the polymer from which they were made, measured as cumulative pore volume as a function of pore width.

FIG. 3 is a graph illustrating the Pd affinity of the adsorbents of Example 1 after sizing to a desired particle size compared to two commercially available adsorbents.

FIG. 4 is a graph illustrating the Pd affinity of the adsorbents of Example 1 after sizing to a desired particle size using 80 mg of adsorbent and 20 mg of adsorbent.

FIG. 5 is a graph illustrating the Pd capacity of the adsorbents of Example 1 after sizing to a desired particle size compared to two commercially available adsorbents.

FIG. 6 illustrates the adsorption kinetics of an adsorbent of Example 1 after sizing to a desired particle size compared to a commercially available silicon-based adsorbent.

FIG. 7 is a graph illustrating the Pd affinity of adsorbents of Example 1 after sizing to a desired particle size compared to two commercially available adsorbents in a polar solvent.

FIG. 8 is a graph illustrating the Pd affinity of adsorbents of Example 1 after sizing to a desired particle size compared to two commercially available adsorbents in the presence of the active pharmaceutical ingredient ibuprofen.

FIG. 9 is a graph illustrating the Pd affinity of adsorbents of Example 1 after sizing to a desired particle size compared to two commercially available adsorbents in the presence of the active pharmaceutical ingredient quinine.

FIG. 10 is a graph illustrating the Cu affinity of adsorbents of Example 1 after sizing to a desired particle size compared to two commercially available adsorbents.

FIG. 11 is a graph illustrating the Pd capacity of the adsorbents of Example 1D, 1E and Example 9B after sizing to a desired particle size compared to a commercially available adsorbent.

FIG. 12 is a graph illustrating the particle size distribution of the adsorbent product of Example 11.

### DETAILED DESCRIPTION OF THE DISCLOSURE

Disclosed herein are functionalized polymer adsorbents and a process using the adsorbents for removing contaminants from liquid compositions. The adsorbents and process find particular utility where the liquid compositions are solutions or streams comprising active pharmaceutical ingredients (API), and the contaminants are elemental impurities, although the adsorbents and processes are not limited to such solutions or streams or to such elemental impurities. Also disclosed is a method of making the adsorbents.

The terms “remove” and “removal” as used herein when applied to a contaminant in a composition mean that the concentration of the contaminant in the composition is reduced compared to its initial concentration in the composition, but do not require that the concentration of the contaminant be reduced to zero %.

The term C₁-C₆alkyl as used herein means a saturated alkyl group having 1-6 carbon atoms, and which group can be linear, branched, or cyclic.

The terms “pore size,” “pore diameter,” and “pore width” are used herein interchangeably. The average pore size is determined by the formula 4V/A, where V is the measured pore volume and A is the measured BET gravimetric surface area, where both V and A are measured by nitrogen isotherms. Nitrogen isotherms reported herein were measured at 77K using a Micromeritics Tristar 3020 porosity analyzer.

The term “pore size distribution DX of Y” as used herein means that X % of the pores of the sample are of a size smaller than Y. For example, “pore size distribution D50=90 Å” means that 50% of the pores in the sample have a pore size of less than 90 Å.

The term “particle size distribution DX of [range]” means that X % of the particles fall within that range. For example, “particle size distribution D90 of 50-150 microns” means that 90% of the particles in a sample have a size of 50-150 microns.

### The Adsorbents

Disclosed herein are adsorbents which in one aspect are based on particles of polymer functionalized through a linker group with at least one functional moiety capable of binding one or more contaminants, the polymer being a macroreticular polymer, the functionalized polymer adsorbent having a pore volume of at least 0.65 cm³/g. In one embodiment the adsorbent particles have an average particle size of less than 150 microns. In one embodiment, the adsorbent particles have a particle size distribution D90 ranging from about 50-150 microns.

Macroreticular polymers as used herein are tough, rigid spongelike materials with large discrete pores, that are generally cross-linked and do not dissolve in water or organic solvents. In one embodiment the macroreticular polymer from which the adsorbent is made will have available olefin groups which can be pendant from the polymer backbone or can be included within the polymer backbone. Some macroreticular polymers are based on polystyrene. One type of macroreticular polymer is based on copolymers of ethylvinylbenzene and divinyl benzene. Commercially available macroreticular polymers include Amberlite® polymers produced by DuPont. Amberlite® polymers suitable for use in the disclosed adsorbents include without limitation Amberlite® XAD4 and Amberlite® XAD16. In some embodiments the macroreticular polymers as used herein prior to functionalization have average pore diameter in the range of 10-300 Å, with a peak in the range of 100-250 Å, as measured by nitrogen uptake isotherms coupled with DFT transform.

Nitrogen isotherms of the starting polymers or of the polymer adsorbents made by functionalizing the polymers can be used to determine the Brunauer-Emmett-Teller (BET)surface area and the pore volume. The macroreticular polymer particles after functionalization to form adsorbents can have a BET surface area of greater than 300 m²/g. In some embodiments the functionalized macroreticular polymer particles can have a BET surface area of greater than 350 m²/g, or greater than 400 m²/g, or greater than 450 m²/g. The BET surface area may depend on the extent of functionalization, the size of the linker group, and the size of the functional moiety.

The macroreticular polymer particles after functionalization to form adsorbents can have a pore volume greater than 0.65 cm³/g, or greater than 0.7 cm³/g, or greater than 0.8 cm³/g, or greater than 0.9 cm³/g, or greater than 1.0 cm³/g, as measured by nitrogen isotherms.

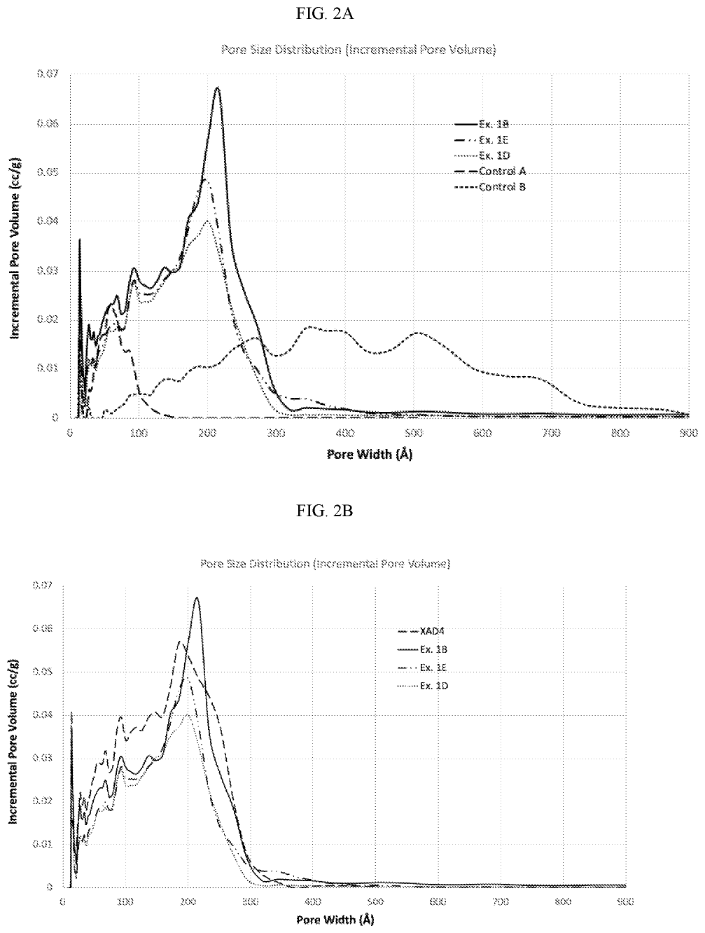

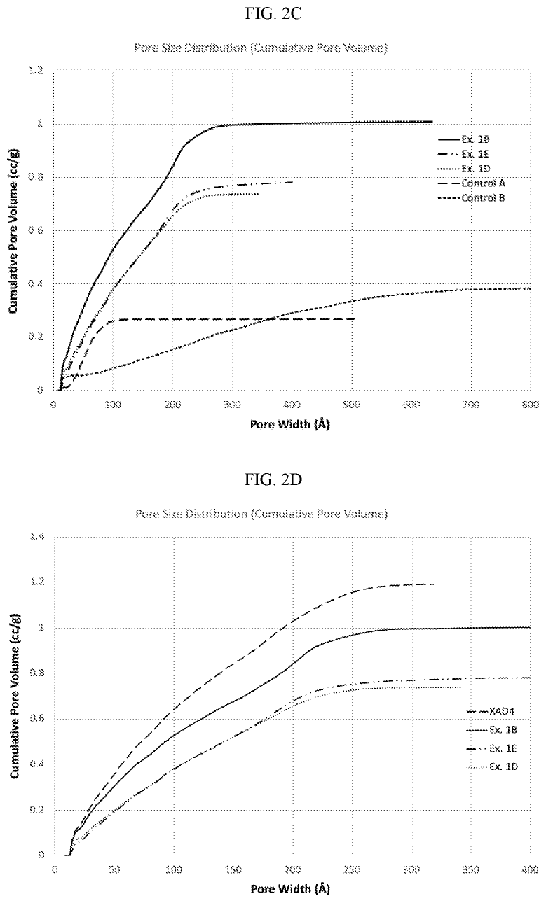

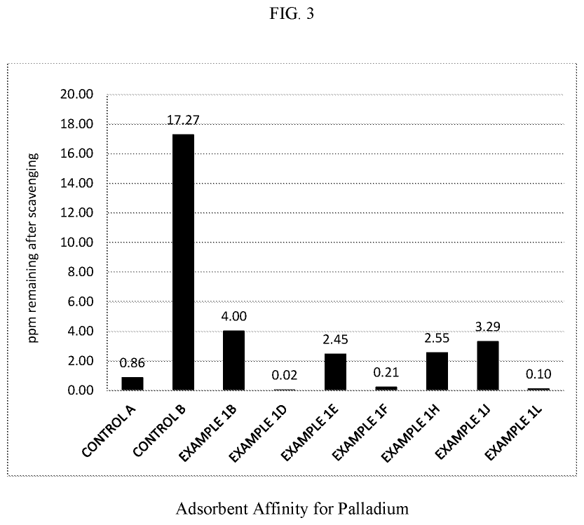

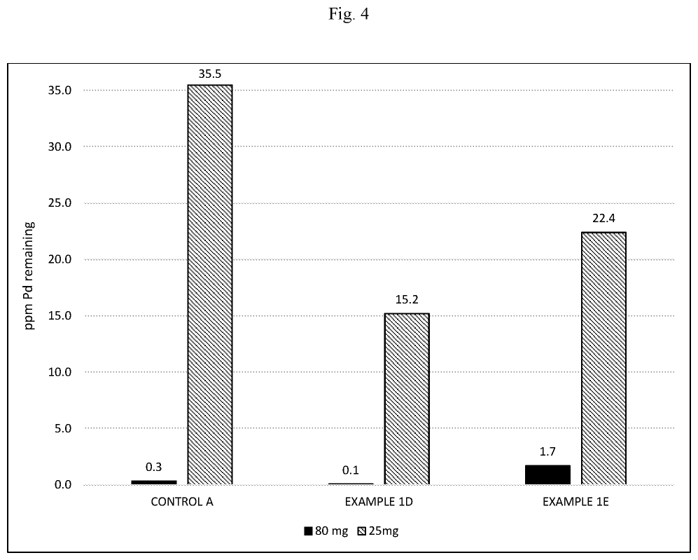

The macroreticular polymer particles after functionalization have an average pore size in the range of 20-200 Å, or 50-150 Å, or 60-100 Å. In one embodiment the functionalized porous particles have a pore size distribution (FIGS. 2C and 2D) wherein D50 is less than 200 Å, or less than 150 Å, or less than 125 Å. In one embodiment the D50 pore size is in the range of 60-140 Å, or 70-130 Å, or 80-120 Å, or 90-110 Å. In one embodiment the functionalized porous particles have a pore size distribution wherein D90 is less than 400 Å, or less than 350 Å, or less than 325 Å, or less than 300 Å. In one embodiment the D90 pore size is in the range of 100-500 Å, or 125-400 Å, or 150-300 Å, or 150-250 Å. In one embodiment the functionalized porous particles have a pore size distribution wherein D10 is less than 100 Å, or less than 80 Å, or less than 60 Å, or less than 40 Å. In one embodiment the D10 pore size is in the range of 10-50 Å, or 15-40 Å, or 15-30 Å.

The average particle size of the functionalized macroreticular polymers disclosed herein can be less than 150 microns, or less than 100 microns, or less than 50 microns. In one embodiment the average particle size is in the range of 50-150 microns. In one embodiment the average particle size is in the range of 50-100 microns. In one embodiment the average particle size is in the range of 100-150 microns. In one embodiment the average particle size is less than 50 microns. Such reduced particle sizes can be achieved by functionalizing the desired sized particles directly as obtained from the manufacturer, or by techniques such as grinding, milling, and crushing of larger sized particles. Following the particle size reduction step the polymer product can be sieved to obtain the particles within the desired size range. The particle reduction step can be performed either before or after the polymer is functionalized with the functional moiety, but it is preferred to reduce the particle size, if necessary, before the functionalization step.

In one embodiment, the functionalized macroreticular polymer adsorbent particles have a particle size distribution D90 ranging from about 50-150 microns. In one embodiment, the functionalized macroreticular polymers have a particle size distribution D90 ranging from about 70-130 microns. In one embodiment, the functionalized macroreticular polymers have a particle size distribution D90 ranging from about 80-120 microns. In one embodiment, the functionalized macroreticular polymers have a particle size distribution D90 ranging from about 85-100 microns. In one embodiment, the functionalized macroreticular polymers have a particle size distribution D50 ranging from about 20-70 microns. In one embodiment, the functionalized macroreticular polymers have a particle size distribution D50 ranging from about 30-60 microns. In one embodiment, the functionalized macroreticular polymers have a particle size distribution D50 ranging from about 40-50 microns. To limit the proportion of extra fines in the adsorbent product, which may cause pressure drop buildup and plugging the filters, in one embodiment, the ratio of D50/D10 is less than 150; in one embodiment, the ratio of D50/D10 is less than 120, and in one embodiment, the ratio of D50/D10 is less than 100. To limit the number of larger particles in the adsorbent product, which may reduce the adsorption efficiency, in one embodiment, the ratio of D90/D50 is less than 10; in one embodiment, the ratio of D90/D50 is less than 7; in one embodiment, the ratio of D90/D50 is less than 5.

In another embodiment the average particle size of the functionalized macroreticular polymers disclosed herein can be in the range of about 50-300 microns, or in the range of 125-250 microns.

The adsorbent polymer particles are functionalized with at least one functional moiety capable of binding one or more contaminants. In one embodiment the at least one functional moiety is linked to the polymer by a thioether linkage. The at least one functional moiety can contain one or more thiol groups, one or more thio groups, a combination of thiol groups and amino groups, or a combination of thio groups and amino groups. Suitable functional moieties include without limitation cysteamine, dimercapto triazine, trimercapto triazine, 2,4,6,-dimercaptotriazine-ethylenedithiol (DMT-EDT) adduct, 2,4,6,-trimercaptotriazine-ethylenedithiol (TMT-EDT) adduct, thioglycolic acid (TGA), thiourea, 4-mercapto pyridine, 1,4,7,10-Tetraazacyclododecane-1,4,7,10-tetraacetic acid (DOTA), ethylenediaminetetraacetic acid (EDTA), thiosulfate (TS), mercaptomethyl phosphonic acid (MPA), trimercaptotriazine-methyl-phosphonic acid (TMT-PA), and mixtures of any of the foregoing. These functional moieties are preferred where the elemental impurity is a metal impurity, particularly palladium. In one embodiment the functional moieties include without limitation cysteamine, dimercapto triazine, trimercapto triazine, 2,4,6,-dimercaptotriazine-ethylenedithiol (DMT-EDT) adduct, 2,4,6,-trimercaptotriazine-ethylenedithiol (TMT-EDT) adduct, and mixtures of any of the foregoing. In one embodiment the functional moieties are selected from 2,4,6,-dimercaptotriazine-ethylenedithiol (DMT-EDT) adduct, 2,4,6,-trimercaptotriazine-ethylenedithiol (TMT-EDT) adduct, and mixtures of any of the foregoing.

In one aspect, Applicants have developed adsorbents comprising particles of polymer functionalized with at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing, and wherein the polymer is a macroreticular polymer. In one embodiment the adsorbent particles having at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing have an average particle size in the range of about 100-300 microns, or in the range of 125-250 microns. In one embodiment the adsorbent particles having at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing have an average particle size of less than 150 microns.

Surprisingly, it has been found that macroreticular polymer-based adsorbents as disclosed herein have significantly improved properties relative to both commercially available polymer-based adsorbents and commercially available silica-based adsorbents. In particular, the rate of reaction between the disclosed adsorbents and the impurities is up to an order of magnitude faster compared to commercially available adsorbents; the affinity of the disclosed adsorbents for the impurities to be removed is superior to commercially available adsorbents; and the capacity of the disclosed adsorbents for the impurities to be removed is significantly superior to that of commercially available adsorbents.

### Synthesis of the Adsorbents

Disclosed herein is a method of making the functionalized polymer adsorbents. The adsorbents disclosed herein, and the method of using the adsorbents to reduce the concentration of a contaminant in a liquid composition, are not necessarily limited to those adsorbents made by the following disclosed method.

A method to synthesize the adsorbents as disclosed herein comprises the steps of
a.) reacting a polymer comprising alkene groups with a first reactant comprising a thiol group and a linking group, whereby a first reactant thiol group reacts with a polymer alkene group in a thiol-ene reaction to form a first intermediate having a thioether linkage between said polymer and said linking group,
b.) reacting said first intermediate with a second reactant comprising an aryl or heteroaryl group, wherein said aryl group or heteroaryl group is substituted or unsubstituted, to form a second intermediate having said substituted or unsubstituted aryl or heteroaryl group bound directly or indirectly to the linking group, and
c.) reacting said second intermediate with a third reactant to convert said bound substituted or unsubstituted aryl or heteroaryl group to a functional moiety, thereby functionalizing said polymer with said functional moiety.
   The functional moiety is selected to be capable of binding one or more contaminants.

The first reactant is reacted with the polymer, optionally in the presence of an initiator, to facilitate a thiol-ene reaction between the thiol group of the first reactant and the alkene group of the polymer to form the first intermediate. In one embodiment the first reactant can be a thiol compound of the formula HS-C₁-C₆alkyl-R wherein the moiety R comprises a linking group which can be selected from saturated and unsaturated alkyl, aryl, heteroaryl, halide, —OH, —NH₂, —NHR′, —NR′₂, —COOH, —NO₂, —COH, —CO(NH₂), —CO(NR′H), —CO(NR′₂), —CN, and —N(OH)NO, where each R′ is independently —C₁-C₆alkyl. The moiety R can further include an alkyl or aryl bridge between the thiol group and the linking group. In one embodiment the linking group is —NH₂, and the moiety R is —C₁-C₆alkylNH₂. In one embodiment the first reactant is HSC₂H₄NH₂. In another embodiment the first reactant can be a thiol compound of the formula HS—Ar—R, where Ar is an optionally substituted aryl or heteroaryl group which can be monocyclic, bicyclic or polycyclic, and R is defined as above.

The second reactant comprises an aryl or heteroaryl group that can be substituted or unsubstituted and that reacts with the linking group of the first intermediate to form a second intermediate. The aryl or heteroaryl group can be monocyclic, bicyclic, or polycyclic. Optionally the substituents can include halide, preferably chloride. In one embodiment the second reactant comprises a heteroaryl group. In one embodiment the heteroaryl group is triazine. In one embodiment the second reactant is cyanuric chloride.

The third reactant reacts with the second intermediate to form the functional moiety. Where it is desired that the functional moiety includes one or more thiol groups, then the third reactant can include one or more thiol groups. The third reactant can be a sulfide salt or an alkyl thiol or alkylpolythiol. In one embodiment the third reactant can be NaSH. In one embodiment the third reactant can be selected from HS-C₁-C₆alkyl-SH, with HS-C₂H₄—SH preferred.

An exemplary method of synthesizing the adsorbents as disclosed herein can be illustrated in the following Scheme 1 as

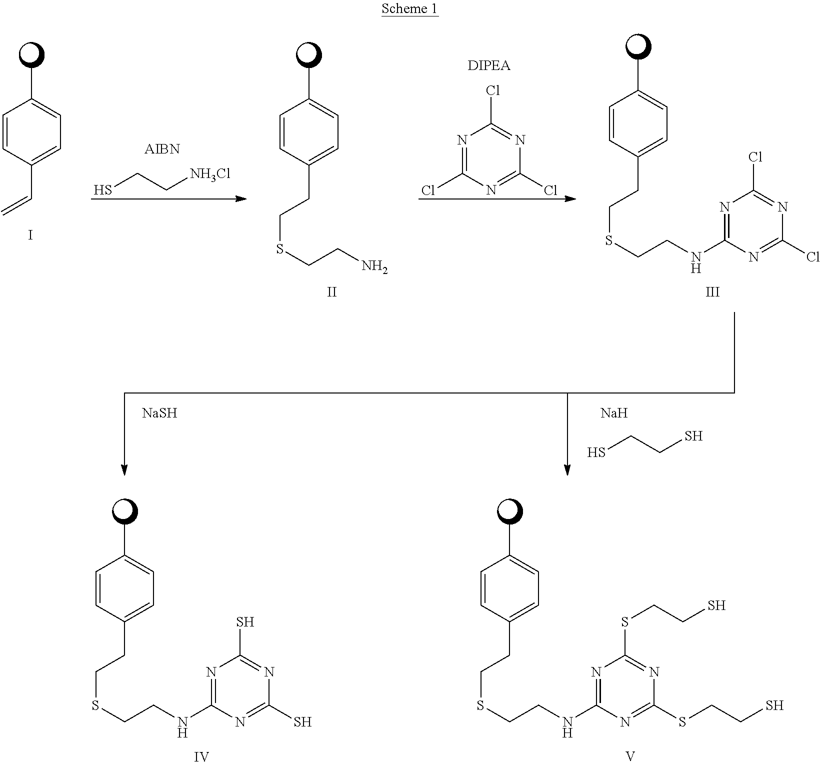

wherein AIBN is the initiator azobisisobutyronitrile and DIPEA is the base N, N-diisopropylethylamine. The starting material (I) is a polymer having alkene groups, illustrated as pendant olefin groups. Macroreticular polystyrenes and macroreticular copolymers of ethylvinylbenzene and divinyl benzene are particularly suitable. The starting material (I) is reacted with a first reactant which can be a thioalkylamine or a salt thereof, such as cysteamine or cysteamine chloride, optionally in the presence of an initiator, exemplified by AIBN, to produce a first intermediate thioalkylamine functionalized polymer (II) having a pendant amino group. The thioalkylamine functionalized polymer (II) can itself serve as a suitable adsorbent for certain impurities. Therefore, the reaction can be deemed complete after this first functionalization step, or, if other functional groups are desired, the reaction can continue through the next steps. If further functionalization is desired, the thioalkylamine functionalized polymer (II) is reacted with a second reactant which can be a halogenated triazine, such as cyanuric chloride, to form a second intermediate which is a polymer (III) having a pendant halogenated triazine group. The polymer (III) can be reacted with a third reactant which can be a sulfide salt, to form a polymer (IV) functionalized with a thioalkylaminodimercaptotriazine group, or the third reactant can be a dithioalkyl such as ethane dithiol, to form a polymer (V) functionalized with a thioalkylaminodimercaptotriazaine-ethylenedithiol adduct.

### Process for Reducing the Concentration of Contaminants

A process for reducing the concentration of at least one contaminant in a liquid composition comprises contacting the liquid composition with an adsorbent as disclosed herein at purification conditions to adsorb at least a portion of the at least one contaminant. In one embodiment the liquid composition is a composition in the process for the manufacture of an active pharmaceutical ingredient. In one embodiment the composition includes an active pharmaceutical ingredient or a precursor thereof, each of which may be referred to interchangeably as an API.

In June 2013, the International Council for Harmonization (ICH) of Technical Requirements for Pharmaceuticals for Human Use established guidelines for the amount of elemental impurities in drug products. The latest guidelines labeled Q3D (R1) were adopted in March 2019. Elemental impurities are present in drug products either because of impurities or residual amounts of catalytic metals. Since these elemental impurities do not provide any therapeutic benefit to the patient, they must be controlled within a narrow range. The ICH, based on toxicity data of elemental impurities, established a Permitted Daily Exposure (PDE) for each elemental impurity. A PDE for each elemental impurity was calculated based on the route of administration, i.e., oral, parenteral or inhalation and the amount of drug taken per day. The ICH further grouped the elemental impurities into several classes. Class 1 is composed of elements As, Cd, Hg, and Pb which are human toxicants and have little or no use in the manufacture of pharmaceuticals. Class 2 is further broken down into Class 2A and Class 2B. The elements in class 2 are route-dependent (how administered) human toxicants. The elements in Class 2A have a higher probability of occurring in pharmaceuticals. Class 2A elements are Co, Ni and V. Class 2B elements which have a lower probability of being present are Ag, Au, Ir, Os, Pd, Pt, Rh, Ru, Se, and Tl. Class 3 elements have a lower toxicity for oral administration and are Ba, Cr, Cu, Li, Mo, Sb, and Sn. The PDE for the various elemental impurities and the route of administration are presented in Table A.2.1 from the guidelines and is reproduced below.

TABLE A.2.1
Permitted Daily Exposure for Elemental Impurities¹

| | | Oral PDE | Parenteral PDE, | Inhalation PDE, |
|---|---|---|---|---|
| Element | Class | μg/day | μg/day | μg/day |
| Cd | 1 | 5 | 2 | 3 |
| Pb | 1 | 5 | 5 | 5 |
| As | 1 | 15 | 15 | 2 |
| Hg | 1 | 30 | 3 | 1 |
| Co | 2A | 50 | 5 | 3 |
| V | 2A | 100 | 10 | 1 |
| Ni | 2A | 200 | 20 | 5 |
| Tl | 2B | 8 | 8 | 8 |
| Au | 2B | 100 | 100 | 1 |
| Pd | 2B | 100 | 10 | 1 |
| Ir | 2B | 100 | 10 | 1 |
| Os | 2B | 100 | 10 | 1 |
| Rh | 2B | 100 | 10 | 1 |
| Ru | 2B | 100 | 10 | 1 |
| Se | 2B | 150 | 80 | 130 |
| Ag | 2B | 150 | 10 | 7 |
| Pt | 2B | 100 | 10 | 1 |
| Li | 3 | 550 | 250 | 25 |
| Sb | 3 | 1200 | 90 | 20 |
| Ba | 3 | 1400 | 700 | 300 |
| Mo | 3 | 3000 | 1500 | 10 |
| Cu | 3 | 3000 | 300 | 30 |
| Sn | 3 | 6000 | 600 | 60 |
| Cr | 3 | 11000 | 1100 | 3 |

¹Table A.2.1 is reproduced with permission from the ICH Guideline Q3D (R1) which may be accessed at https://www.ema.europa.eu/en/documents/scientific-guideline/international-conference-harmonisation-technical-requirements-registration-pharmaceuticals-human-useen-32.pdf

A feed stream or feed solution (terms will be used interchangeably) contains an API and one or more contaminants, e.g. the elemental impurities enumerated above. The stream or solution comprises either an organic solvent or an aqueous solvent. The solvent may be the solvent, which was used to synthesize the API, or if more than one step is needed to synthesize the API the solvent may be the solvent used in the last reaction step or the solvent used to purify the API. Exemplary solvents include but are not limited to water, methanol, ethanol, isopropanol, butanol, t-butyl alcohol, acetone, dimethyl sulfoxide, dimethylformamide, ethyl acetate, isopropyl acetate, methyl-tertbutyl ether, diethyl ether, dichloromethane, chloroform, benzene, toluene, xylene, hexanes, dichlorobenzene, acetonitrile, N-methyl-2-pyrrolidone, 4-dimethylamino-pyridine, hexamethylphosphoramide, tetrahydrofuran, ethylene glycol, and mixtures of any of the foregoing.

The feed stream can also contain contaminants which include but are not limited to additives, by-products, unreacted starting materials, and catalyst degradation products. Although the process described below can be used to remove elemental impurities, and/or other contaminants, the process will be described using elemental impurities, but it is to be understood that the process is not limited to removing only elemental impurities.

The functionalized polymer adsorbent is contacted with the feed stream at purification conditions in order for the adsorbent to adsorb and remove the unwanted elemental impurity from the feed stream and provide a purified API stream. The adsorbent and API comprising feed stream may be contacted in a batch system by admixing the feed stream and adsorbent in a suitable vessel to provide the purified API stream. The purification step can be conducted at conditions which includes a temperature of about −50° C. to about 120° C., or about −20° C. to about 100° C., or about 0° C. to about 80° C., or from about 10° C. to about 70° C., or from about 20° C. to about 60° C. Advantageously, the functionalized polymers of the present disclosure perform well at ambient temperatures and require no special temperature controls; other temperatures can be used depending on the manufacturing process of the active pharmaceutical ingredient.

Another purification condition is the time required to achieve the desired removal of elemental impurity. Advantageously, the functionalized polymers as disclosed herein provide improved reaction kinetics, and may use shorter contact times than adsorbents of the prior art. The contact time can vary considerably and is dependent on the contact temperature, pH of the feed stream and pressure. Generally, the contact time is from about a few seconds to several days, more specifically from about 5 seconds to about 3 days, or from about 1 minute to about 1 day, or from about 10 minutes to about 18 hours or from about 20 minutes to about 12 hours, or from about 40 minutes to about 8 hours or from about 1 hour to about 6 hours. Optionally the mixture can be stirred or agitated to increase contact between the adsorbent and feed stream in order to decrease the time required to achieve the desired final concentration of the metal impurity. Agitation can be carried out by using a shaking table, orbital shaker, or other suitable device. Stirring can be carried out using a mechanical stirrer and the stirring rate is adjusted to provide from about 0.2 turnovers per minute to about 15 turnovers per minute or from about 0.5 turnovers per minute to about 10 turnovers per minute or from about 1 turnover per minute to about 8 turnovers per minute. If it is determined that after a given amount of time the concentration has reached a plateau, but the elemental impurity concentration is still above the required limit, the API stream can be separated from the adsorbent and the API stream contacted with a fresh quantity of adsorbent. The w/w %, i.e., weight of adsorbent/weight of stream, between the two purification steps does not have to be the same. That is, the amount of adsorbent used in the first step can be more or less than the amount of adsorbent in the second step. For example, w/w % in the first step can vary from about 0.1 w/w % to about 70 w/w % or from about 0.5 w/w % to about 60 w/w % or from about 1 w/w % to about 50 w/w % or from about 2 w/w % to about 40 w/w % or from about 5 w/w % to about 30 w/w % or from about 1 w/w % to about 30 w/w % or from about 0.5 w/w % to about 60 w/w % or from about 1 w/w % to about 50 w/w % or from about 2 w/w % to about 40 w/w % or from about 5 w/w % to about 30 w/w %. In the second step the w/w % can vary from about 0.1 w/w % to about 70 w/w % or from about 0.5 w/w % to about 60 w/w % or from about 1 w/w % to about 50 w/w % or from about 2 w/w % to about 40 w/w % or from about 5 w/w % to about 30 w/w %.

Another parameter which can be adjusted is the pH of the feed stream. The pH can have an effect on the affinity of the functional moiety for the specific elemental impurity being removed. The optimum pH or pH range can be different for different functional moieties and this optimum pH or range can be determined experimentally.

The adsorbent used in the above-described batch process can be a mixture of two or more adsorbents in order to optimize the removal of multiple elemental impurities, wherein at least one of the adsorbents is a functionalized polymer as disclosed herein, and at least one of the other adsorbents can be either another functionalized polymer as disclosed herein or another adsorbent such as an activated carbon, a silica-based adsorbent, or a metal organic framework (MOF) based adsorbent. It can be experimentally determined which adsorbents better adsorb one elemental impurity versus another and thus an optimum mixture of adsorbents can be obtained to purify any API feed stream based on the makeup of the elemental impurities in the feed stream. The two or more adsorbents can be mixed together. Alternatively, instead of using a mixture of adsorbents in one vessel, the process can be carried out by admixing the API feed stream with a first adsorbent in one vessel, separating (by well-known means) the adsorbent from the partially purified stream and then admixing the partially purified stream with a second adsorbent in a second vessel at similar or different purification conditions to provide the purified API stream.

The amount of the two adsorbents can be the same or different. The relative amount of each adsorbent can vary substantially based on the affinity of an adsorbent for a particular elemental impurity or the total capacity of the adsorbent for the elemental impurity. The purification conditions used for each adsorbent (if used in different vessels) can also be adjusted to optimize elemental impurity removal. The maximum concentration of the elemental impurity in the purified API stream which must be achieved is dependent on the PDE of the elemental impurity, the concentration of the elemental impurity in the API feed stream and the final concentration of the elemental impurity in the API (Table A.2.1).

In another aspect, the method is carried out as a continuous process in which the adsorbent is placed in a bed through which flows the feed stream comprising the API and the one or more contaminants. In one embodiment the bed can be in the form of a rigid configuration such as a column. The column can have any type of shape such as square, rectangular or circular. Circular columns are the most common type of columns. The feed stream is introduced through one or more inlet ports and the feed stream flowed downward or upward through the column. In a particular aspect, two or more inlet ports are used in order to ensure uniform distribution of the feed stream radially across the column. The one or more inlet ports can be spaced around the circumference of the column. When the feed stream is down flowed a particular arrangement is a shower arrangement or configuration which is located at the top end or cap of the column allowing a shower of feed stream to contact the adsorbent with the most even distribution radially across the column.

The inlet ports can have any shape well known in the art such as orifices whose outlet diameter and shape determines the area and flow pattern that the orifice can cover. The purified API stream is removed from an outlet port and passed to other vessels or reactors to isolate the API.

The column is sized depending on the amount of feed stream to be purified. The ratio of the height to the diameter of a column can vary considerably. Factors to be taken into considerations include the amount of back pressure created, flow rate of the feed stream, i.e., contact time, the amount of drug to be purified, the purification levels necessary, and the efficacy of the column media. For example, a high ratio of height:diameter may create more backpressure and increase the time required to pass the feed stream through the column. A low (or lower) height:diameter ratio will decrease the backpressure, but the contact time will be shorter and radial flow distribution may not be as even. Using computational fluid dynamics (CFD) one can model various configurations and arrive at an optimum configuration.

In order to ensure that elemental impurity concentration of the purified stream meets the ICH guidelines for the particular elemental impurity, the flow rate needs to be controlled to ensure sufficient contact time between the feed stream and the adsorbent since the contact time is dependent on the flow rate of the feed stream and the size of the reactor, i.e. the cross-sectional area of the reactor. Linear velocity is a parameter which takes into account the size of the reactor and thus is a better parameter to use. The linear velocity can range from about 0.02 to about 300 cm/min. or from about 0.05 to about 200 cm/min. or from about 0.1 to about 100 cm/min. or from about 0.2 to about 50 cm/min.

The column can be operated over a broad temperature range. The low end of the range is dependent on the temperature the API starts to precipitate from the solution. The temperature varies from about −50° C. to about 120° C. or about −20° C. to about 100° C. or about 0° C. to about 80° C. or from about 10° C. to about 70° C. or from about 20° C. to about 60° C. Although the column can be operated at atmospheric pressure, it can be operated over a wide pressure range from below atmospheric pressure to above atmospheric pressure. Generally, the pressure range can be from about 0.01 kPa to about 1000 kPa or from about 5 kPa to about 500 kPa or from about 10 kPa to about 200 kPa or from about 20 kPa to about 100 kPa.

Although only one adsorbent material can be used in the column, if the feed stream contains more than one elemental impurity, it may be advantageous to use more than one adsorbent, wherein at least one of the adsorbents is a functionalized polymer as disclosed herein, and at least one of the other adsorbents can be either another functionalized polymer as disclosed herein or another adsorbent such as an activated carbon, a silica-based adsorbent, or a MOF-based adsorbent. In this case the different adsorbents can be first mixed together and used to fill the column. Alternatively, the two or more adsorbents can be placed in the column in alternating layers. The layers do not need to be of equal size but can be sized depending on the affinity of the adsorbent for a particular elemental impurity or the adsorption capacity of the adsorbent(s) for an elemental impurity or the concentration of the elemental impurity in the feed stream. The order of the adsorbents in the column is also determined by the affinity and adsorption capacity of each adsorbent for the various elemental impurities. It is also possible to use a plurality of columns, and in which the adsorbents in each column can be the same or different.

If the stream exiting the purification column has a concentration of the one or more elemental impurities above its PDE, then the exit stream may either be passed through the same column a second time or multiple times. This can be accomplished by the use of a circulation loop on the side of the column or reactor which takes an exit stream from a loop outlet port proximate to the outlet port and passes the stream to a loop inlet port on the column or reactor proximate to the inlet port. Alternatively, the exit stream may be passed through a second column containing fresh adsorbents. The second column can contain the same adsorbents as the first column or different adsorbents or a different axial arrangement of the adsorbents. In one aspect the feed stream is flowed through the purification column once and the exit stream is the purified stream which meets the ICH guidelines for elemental impurities.

In the foregoing embodiments of the method, whether in batch mode or continuous mode, where more than one adsorbent is used, then at least one of said adsorbents is a functionalized macroreticular polymer of average particle size less than 150 microns as described herein, and the other one or more additional adsorbents can be other functionalized macroreticular polymer of average particle size less than 150 microns or can be such adsorbents of different particle size, or other types of adsorbents such as activated carbon, silica-based adsorbents or MOF-based adsorbents.

Use of the adsorbents and method disclosed herein has been shown to provide improved performance in the areas of adsorbent affinity for the impurity to be removed, reaction kinetics, and adsorbent capacity. In one embodiment, the process reduces the concentration of the elemental impurity to less than 5 ppm of the API product stream. In one embodiment, the process reduces the concentration of the elemental impurity to less than 2 ppm of the API product stream. In one embodiment, the process reduces the concentration of the elemental impurity to less than 1 ppm of the API product stream.

In the Examples below the following abbreviations are used:

CA—cysteamine

DCT—dichlorotriazine

DIPEA—N,N-diisopropylethylamine

DMF—dimethyl formamide

DMT—dimercaptotriazine

EDT—ethane dithiol

MeOH—methanol

THF—tetrahydrofuran

### EXAMPLES

### Example 1—Preparation of MacroReticular Polymer Adsorbents

### Adsorbents Based on Amberlite® XAD4

A. Reduction of polymer particle size. Amberlite® XAD4 (obtained from Sigma-Aldrich) macroreticular polymer (300 g) was dried in a 100° C. oven overnight to remove water. This dried polymer (136 g) was put in a coffee blade grinder in batches until all the polymer passed through a 250 μm sieve. The sieved polymer was wetted with MeOH and then rinsed with 2 L of water. The polymer was then sized by passing it through a 125 and 53 μm sieve under a stream of water. Once the water coming out of the sieve was clear the 125-53 μm fraction was dried in a 100° C. oven overnight. Final yield was 31 g 125-53 μm polymer.

B. Functionalization with cysteamine, full-sized polymer particles. In a 1-L Pyrex jar, cysteamine HCl (51.1 g, 450 mmol), PEG-400 (6.6 ml), and AIBN initiator (1.27 g, 1.7 weight % of polymer) were dissolved in DMF (470 ml). Amberlite® XAD4 (75 g) as received from the supplier was added. The reaction was heated at 80° C. in an oven overnight. The resulting CA-functionalized polymer product was then washed with approximately 400 ml portions of DMF 2×, MeOH 1×, 1M NaOH (4 hr), Water 3×, MeOH 2×, and MeOH (overnight soak), then dried by rotary evaporation to yield 84 g of product. By elemental analysis the product had 1.46 mmol/g N and 1.00 mmol/g S.

C. Functionalization with Dichlorotriazine, full-sized polymer particles. In a 250-mL Pyrex jar, cyanuric chloride (22.1 g, 120 mmol) was dissolved in THF (120 ml). The solution was cooled to 5° C. in an ice bath and DIPEA (20.9 ml, 120 mmol) was added. 40 g of the CA-functionalized polymer of Example 1B was added in 5 g portions, with about 10 minutes between each addition. The reaction exothermed strongly, but the temperature stayed below 12° C. By the ninhydrin test the polymer product was a pale blue and the ninhydrin solution was clear. After about 4 hours the resulting DCT-functionalized polymer product was washed with acetone twice, then soaked in acetone overnight and dried by rotary evaporation to yield 46 g of product. By elemental analysis the product had 3.11 mmol/g N and 2.00 mmol/g Cl.

D. Conversion of Functionalized DCT to Dimercaptotriazine, full sized polymer particles. In a 100-mL Pyrex jar NaSH (1.12 g, 20 mmol) was dissolved in water (40 ml). 5 g of the DCT-functionalized polymer of Example 1C was solvated with acetone (10 ml) then added to the NaSH solution. The reaction was allowed to proceed at room temperature overnight. The resulting DMT functionalized polymer was washed with water 3×, MeOH 3×, and THF 3×+overnight soak. The final material was dried by rotary evaporation. By elemental analysis the product had 3.30 mmol/g N and 2.21 mmol/g S.

E. Conversion of Functionalized DCT to DMT-ethanedithiol, full sized polymer particles. In a 100-mL Pyrex jar ethane dithiol (2.11 ml, 25.2 mmol) was dissolved in DMF (63 ml). The solution was cooled using an ice bath. 60% suspension of NaH in mineral oil (1.01 g, 25.2 mmol) was then added in four portions. The thiolate solution was allowed to warm to room temperature, then the DCT-functionalized polymer of step C (6.3 g) was added. The reaction was placed in a 100° C. oven overnight. The resulting DMT-EDT functionalized polymer was filtered while warm and washed with DMF 2×, 1M HCl, DMF 2×, water 2×, THF 2×, THF (overnight soak), THF 3×, and then dried by rotary evaporation to yield 6.36 g of product. By elemental analysis the product had 2.55 mmol/g N and 2.39 mmol/g S.

### Adsorbents Based on Amberlite® XAD16

Amberlite® XAD16 was sized to 125-53 μm particles using the procedure of Example 1 Å. After activation at 100° C. the nitrogen uptake at 731 torr was 1101 cm³/g. This process was repeated until the desired amount of sized amberlite was obtained. These reduced size Amberlite® XAD16 particles were used in Examples 1F-1H.

F. Functionalization with cysteamine. In a 250 mL round bottom flask, cysteamine HCl (10.2 g, 90 mmol), PEG-400 (1.3 ml), and AIBN (255 mg, 1.7 weight % of polymer) were dissolved in DMF (94 ml). 125-53 μm Amberlite XAD16 (15 g) was added. The reaction was heated at 70° C. overnight without stirring. The functionalized polymer was then washed with DMF, 1 M aq. NaOH, water, MeOH (overnight). For each wash the polymer was rinsed once with the wash solvent on a filter, then soaked in the solvent for at least 1 hour. The polymer was air dried in a fume hood. By elemental analysis the product had 0.92 mmol/g N and 1.27 mmol/g S. After activation at 100° C. the nitrogen uptake at 735 torr was 896 cm³/g.

G. Functionalization with Dichlorotriazine. To a 200 mL round bottom flask with stir bar was added THF (60 ml) and cyanuric chloride (5.53 g, 30 mmol). Solution was cooled to 5° C. The product of Ex. 1F (10 g) was slowly added followed by slow addition of DIPEA (5.2 ml, 30 mmol). Reaction was kept below 10° C. After the cyanuric chloride was added, the polymer was allowed to react for an additional hour. By the ninhydrin test the polymer product was a pale blue and the ninhydrin solution was clear. The functionalized polymer was then washed with THF and acetone (overnight). For each wash the polymer was rinsed once with the wash solvent on a filter, then soaked in the solvent for at least 1 hour. The polymer was air dried in a fume hood. By elemental analysis the product had 3.00 mmol/g N, 1.67 mmol/g Cl, and 0.96 mmol/g S. After activation at 100° C. the nitrogen uptake at 735 torr was 787 cm³/g.

H. Conversion of Functionalized DCT to Dimercaptotriazine. In a 100-mL Pyrex jar NaSH (1.79 g, 32 mmol) was dissolved in water (30 ml). The polymer of Ex. 1G (8 g) was solvated with THF (16 ml) then added to the NaSH solution. The reaction was allowed to proceed at room temperature overnight. The functionalized polymer was then washed with water, MeOH, and THF (overnight). For each wash the polymer was rinsed twice with the wash solvent on a filter, then soaked in the solvent for at least 1 hour. The resin was air dried in a fume hood. By elemental analysis the product had 3.08 mmol/g N and 2.09 mmol/g S, with Cl below the limit of detection. After activation at 100° C. the nitrogen uptake at 723 torr was 645 cm³/g.

Adsorbents based on pre-sized polymer

I. Reduction of polymer particle size. Amberlite XAD4 (300 g) was dried in a 100° C. oven overnight to remove water. This dried polymer (136 g) was put in a coffee blade grinder in batches until all the polymer particles passed through a 250 μm sieve. This was the smallest size sieve that the polymer would pass through (ground polymer would clog smaller sieve openings because of static electricity). MeOH was added to the <250 μm polymer (just enough to wet it) and then 2 L of water. The polymer was then sized by passing it through a 125 and 53 μm sieve under a stream of water. Once the water coming out of the sieve was clear the 125-53 μm fraction was dried in a 100° C. oven overnight. Final yield was 31 g 125-53 μm amberlite. After activation at 100° C. the nitrogen uptake at 735 torr was 810 cm³/g. This process was repeated until the desired amount of sized polymer was obtained.

J. Functionalization with cysteamine. In a 1-L round-bottom flask with mechanical stirring, cysteamine HCl (40.9 g, 260 mmol), PEG-400 (5.3 ml), and AIBN (1.02 g, 1.7 weight % of amberlite) were dissolved in DMF (375 ml). 125-53 μm Amberlite XAD4 (60 g) from Example 1I. was added. The reaction was heated at 70° C. overnight. The functionalized polymer was then washed with DMF, 1 M aq. NaOH, water, MeOH. For each wash the polymer was rinsed once with about 150 ml of the wash solvent on a filter, then soaked in about 500 ml solvent for at least 1 hour, except for the final MeOH soak which was overnight. The polymer was air dried in a fume hood. By elemental analysis the product had 0.99 mmol/g N and 1.01 mmol/g S. After activation at 100° C. the nitrogen uptake at 735 torr was 647 cm³/g.

K. Functionalization with Dichlorotriazine. To a 1 L round-bottom flask with mechanical stirring was added THF (200 ml), the polymer product of Example 1J (45 g), and DIPEA (24 ml, 135 mmol). Solution was cooled to 5° C. A solution of cyanuric chloride (24.9 g, 135 mmol) in THF (100 ml) was added dropwise. Reaction was kept below 10° C. After the cyanuric chloride was added, the polymer was allowed to react for an additional hour. By the ninhydrin test the polymer product was a pale blue and the ninhydrin solution was clear. The functionalized polymer was then washed with THF and acetone. For each wash the resin was rinsed once with the wash solvent on a filter, then soaked in the solvent for at least 1 hour, except for the final acetone soak which was overnight. The polymer was air dried in a fume hood. By elemental analysis the product had 2.69 mmol/g N, 1.27 mmol/g Cl, and 1.09 mmol/g S. After activation at 100° C. the nitrogen uptake at 735 torr was 542 cm³/g.

L. Conversion of Functionalized DCT to Dimercaptotriazine. In a 250-mL Pyrex jar NaSH (6.73 g, 120 mmol) was dissolved in water (120 ml). The product of example 1K (30 g) was solvated with THF (60 ml) then added to the NaSH solution. The reaction was allowed to proceed at room temperature overnight. The functionalized polymer was then washed with water, MeOH, and THF (overnight). For each wash the polymer was rinsed twice with the wash solvent on a filter, then soak in the solvent for at least 1 hour. The polymer was air dried in a fume hood. By elemental analysis the product had 2.73 mmol/g N, and 1.93 mmol/g S, with Cl beneath the limit of detection, which was 0.4%. After activation at 100° C. the nitrogen uptake at 735 torr was 544 cm³/g.

Samples of each of the functionalized porous polymers of Examples 1B, 1D and 1E were activated at 100° C. and used to take nitrogen isotherms to determine BET surface areas, pore volumes, N2 uptakes, and pore size distributions (See Tables I and II and FIGS. 4, 5A-D) before the particle size reduction step. Control A is a commercially available silica-dimercaptotriazine adsorbent having a particle size in the range of 50-100 μm, average pore diameter of 63 Å, pore volume of 0.34 cm³/g, and N2 uptake of 221 cm³/g. Control B is a commercially available adsorbent comprising trimercaptotriazine on a macroreticular polymer support having a measured average particle size of 150-355 μm, average pore diameter of 93 Å, pore volume of 0.57 cm³/g, and N2 uptake of 377 cm³/g. As a comparison, functionalized porous polymers 1B, 1D, and 1E have average pore diameters of 69, 75, and 84 Å respectively, pore volumes of 1.06, 0.78, and 0.89 cm³/g respectively, and N2 uptakes of 691, 505, and 529 cm³/g respectively.

TABLE I
Porosity properties

| | BET | | |
|---|---|---|---|
| | Surface area | Pore Volume | N₂ Uptake |
| Sample | (m²/g) | (cm³/g)^{a} | (cm³/g) |
| XAD4 | 739 | 1.29 | 839 |
| Control A | 214 | 0.34 | 221 |
| Control B | 239 | 0.57 | 377 |
| Ex. 1B | 608 | 1.06 | 691 |
| Ex. 1D | 413 | 0.78 | 505 |
| Ex. 1E | 390 | 0.89 | 529 |

^{a}Single point adsorption total pore volume of pores

TABLE II
Pore size distributions

| | Average | D10 | D50 | D90 |
|---|---|---|---|---|
| | pore size | pore size | pore size | pore size |
| Sample | (Å)^{a} | (Å)^{b} | (Å)^{c} | (Å)^{d} |
| XAD4 | 70 | 18 | 90 | 217 |
| Control A | 63 | 25 | 50 | 84 |
| Control B | 93 | 16 | 270 | 590 |
| Ex. 1B | 69 | 17 | 95 | 215 |
| Ex. 1D | 75 | 20 | 95 | 200 |
| Ex. 1E | 84 | 25 | 100 | 210 |

^{a}Adsorption average pore diameter (4V/A by BET)
^{b}The portion of pores with diameters smaller than this value is 10%.
^{c}The portion of pores with diameters smaller than this value is 50% (median pore size).
^{d}The portion of pores with diameters smaller than this value is 90%.

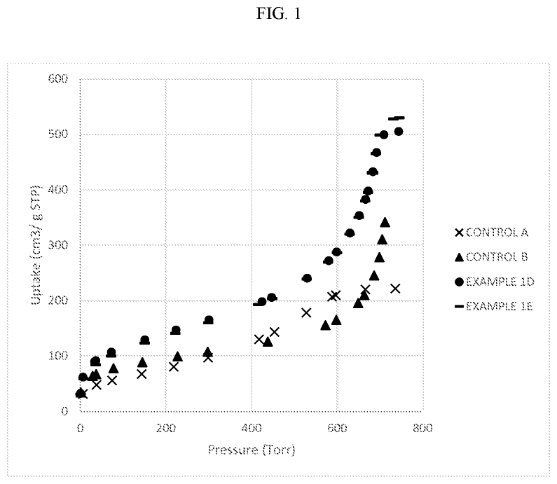

FIG. 1 illustrates isotherm data for the products of Examples 1D and 1E relative to isotherm data for Control A and Control B. The products of Examples 1D and 1E had greater nitrogen uptake than either of the control samples, indicating that these Examples had greater pore volume and surface area than the control samples. Without being bound by theory, it is believed that these parameters lead to improved performance in both adsorption kinetics and adsorbent capacity.

FIG. 2A illustrates the incremental pore size distribution of Examples 1B, 1D and 1E compared to Control A and Control B; FIG. 2B illustrates the incremental pore size distribution of Examples 1B, 1D and 1E compared to the Amberlite XAD4 polymer from which they were made. FIG. 2C illustrates the cumulative pore size distribution of Examples 1B, 1D and 1E compared to Control A and Control B; FIG. 2D illustrates the cumulative pore size distribution of Examples 1B, 1D and 1E compared to the Amberlite XAD4 polymer from which they were made. It may be seen that the adsorbents of each of Examples 1B, 1D and 1E have higher pore volumes than either of the two controls, measured on either an incremental or cumulative basis, which also suggests that the adsorbents of the disclosure will have both improved kinetics and adsorption capacity.

Samples of approximately 5 g of the products of each of Examples 1B, 1D, and 1E were ground and sized in accordance with the procedure of Example 1 Å, and used in the following Examples 2-7.

In the following Examples 2-7 inductively coupled plasma measurements were done on a Thermo iCap7600 ICP-OES with detection limits from 0.001 ppm-100 ppm Pd. UV-visible spectrophotometry measurements were conducted on a MetraSpec Pro with wavelength scans taken from 300 nm-450 nm and detection limits from 1 ppm to 300 ppm Pd.

### Example 2—Measurement of Adsorbent Affinity for Pd

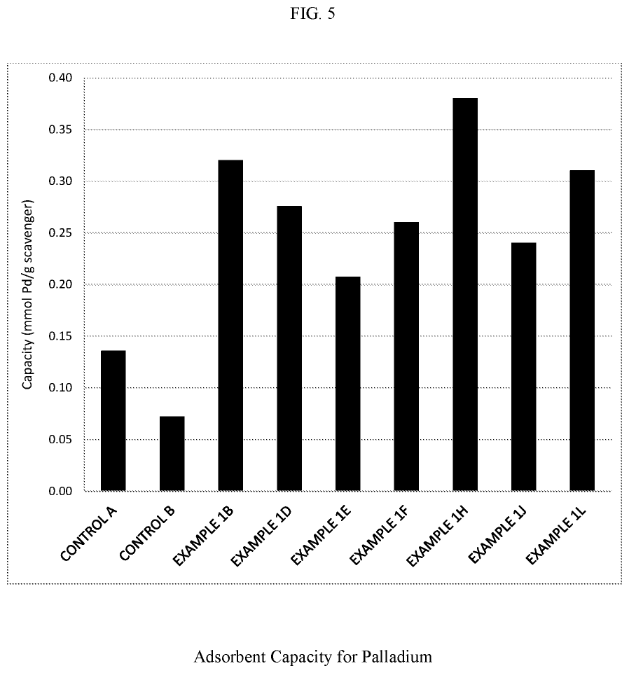

Samples were prepared by adding 80 mg of each adsorbent to be evaluated to 10 ml aliquots of a solution of 85 ppm Pd added as PdCl₂(P(phenyl)₃)₂ (Sigma) in 50:50 dimethylformamide:tetrahydrofuran. The samples were mixed on an orbital shaker at 50 rpm for 24 hours, then filtered using a 0.22 micrometer PTFE syringe filter. Each sample was run in triplicate. The residual Pd in solution was measured by inductively coupled plasma. The results are illustrated in FIG. 3. It may be seen that the adsorbents of Example 1 all achieved less than 5 ppm residual Pd in the sample, Examples 1D, 1F, and 1 L achieved less than 1 ppm residual Pd in the sample, and the adsorbents of Example 1 each performed significantly better than Control B. This Example was repeated using 25 mg instead of 80 mg of each of the adsorbents of Ex 1D and 1E. As shown in FIG. 4, at this lower level the adsorbents of Examples 1D and 1E were superior to Control A in Pd adsorption.

### Example 3—Measurement of Adsorbent Capacity for Pd

Samples were prepared by adding 40 mg of each adsorbent to be evaluated to 20 ml aliquots of a solution of 300 ppm Pd added as PdCl₂(P(phenyl)₃)₂ (Sigma) in 50:50 dimethylformamide:tetrahydrofuran. The samples were mixed on an orbital shaker at 50 rpm for 24 hours, then filtered using a 0.22 micrometer PTFE syringe filter. Each sample was run in triplicate. The residual Pd in solution was measured by UV-visible spectrophotometry. The adsorbents evaluated were each of the adsorbents prepared in Example 1, a commercially available adsorbent comprising DMT on a silica support (Control A), and a commercially available adsorbent comprising TMT on a macroreticular polymer support, in which the reported average particle size was 150-350 μm (Control B). The results are illustrated in FIG. 5. It may be seen that the adsorbents of Example 1 have palladium capacities higher than Control A, and significantly higher than Control B. This allows less of the adsorbent to be used on a weight basis relative to the Controls to achieve the same amount of purification.

The improved Pd capacity of the adsorbents disclosed herein relative to the commercially available adsorbents is consistent with the isotherm data for these samples as illustrated in FIG. 1, wherein it is seen that the adsorbents of the present disclosure exhibit greater uptake of N2 than the commercially available adsorbents at all pressures from zero to 760 torr.

### Example 4—Measurement of Adsorption Kinetics

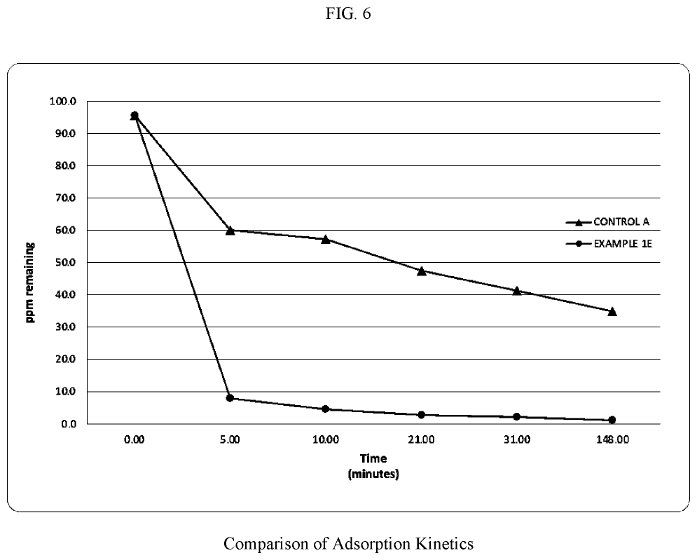

The rate of Pd adsorption was measured for the adsorbent of Example 1E and the commercially available adsorbent of Control A. Samples were prepared by adding 80 mg of each adsorbent to be evaluated to 10 ml aliquots of a solution of 100 ppm Pd added as PdCl₂(P(phenyl)₃)₂ (Sigma) in 50:50 dimethylformamide:tetrahydrofuran. Both the adsorbent of Example 1E and the adsorbent of Control A had an average particle sized in the range of 50-100 μm. The samples were mixed on an orbital shaker at 50 rpm, with samples taken every five minutes, and then returned to the orbital shaker. The amount of Pd remaining in solution was determined by UV-visible spectrophotometry. The kinetic data is presented in FIG. 6, where it may be seen that the adsorbent of Example 1 removed the Pd from the solution to a point below the level of detection of the instrument within five minutes. By comparison, after five minutes the silica-based adsorbent of Control A still had 60 ppm of Pd in solution, and after 50 minutes still had 35 ppm of Pd in solution. This represents a significant advantage of the adsorbents as disclosed herein relative to the silica-based adsorbents of the prior art, in that the duration of the purification step in the manufacture of APIs can be drastically shortened to speed up the API manufacturing cycle.

### Example 5—Measurement of Adsorbent Affinity for Pd in Polar Solvent

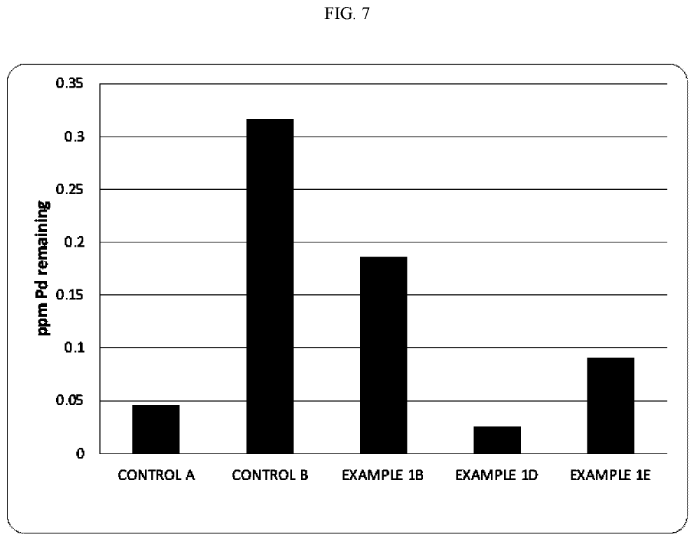

Samples were prepared by adding 80 mg of each adsorbent to be evaluated to 10 ml aliquots of a solution of 100 ppm Pd added as Pd(OAc)₂ (Sigma) in isopropyl alcohol. Isopropyl alcohol is a polar solvent that is a non-swelling solvent for polystyrene. Pd(OAc)₂ was chosen as the Pd salt because it is soluble in isopropyl alcohol, while PdCl₂(P(phenyl)₃)₂ is not. The samples were mixed on an orbital shaker at 50 rpm for 24 hours, and then filtered using a 0.22 micrometer PTFE syringe filter. Each sample was run in triplicate. The residual Pd in solution was measured by inductively coupled plasma. The results are illustrated in FIG. 7. It may be seen that the adsorbents of Example 1 are comparable to or better than Control A and Control B.

### Example 6—Measurement of Adsorbent Affinity for Pd in Presence of API-Ibuprofen

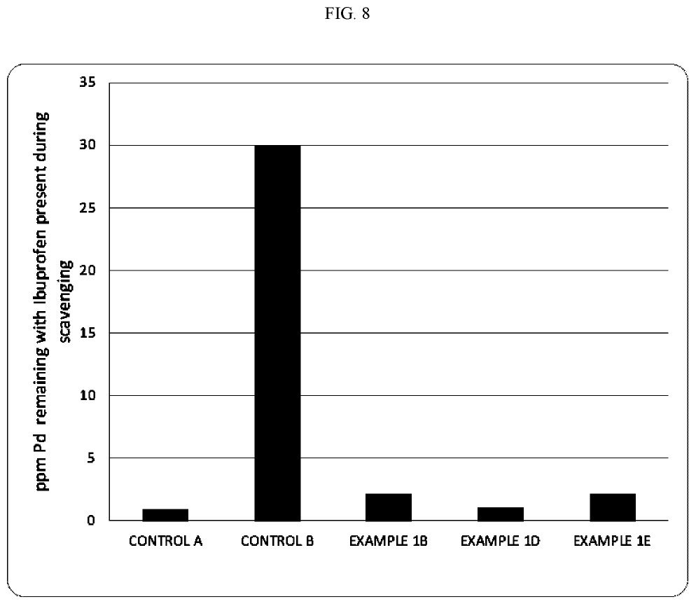

Samples were prepared by adding 80 mg of each adsorbent to be evaluated to 10 ml aliquots of a solution of 80 ppm Pd added as PdCl₂(P(phenyl)₃)₂ (Sigma) in 50:50 dimethylformamide:tetrahydrofuran, along with ibuprofen added at a concentration of 20 mg/ml. The samples were mixed on an orbital shaker at 50 rpm for 24 hours, and then filtered using a 0.22 micrometer PTFE syringe filter. Each sample was run in triplicate. The residual Pd in solution was measured by inductively coupled plasma. The results are illustrated in FIG. 8. It may be seen that the adsorbents of Examples 1B, 1D, and 1E are comparable to Control A, and significantly better than Control B.

### Example 7- Measurement of Adsorbent Affinity for Pd in Presence of API-Quinine

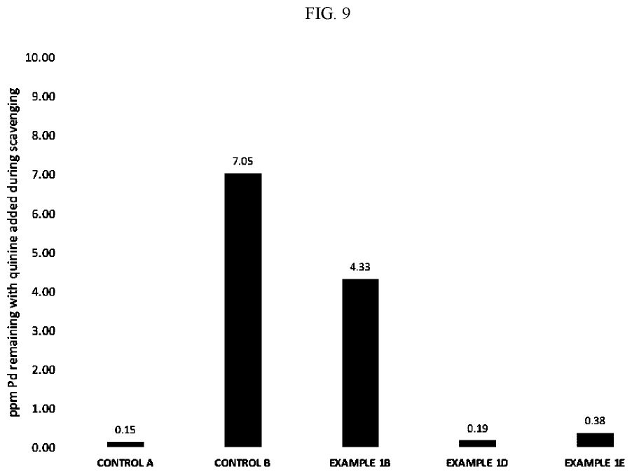

Samples were prepared by adding 80 mg of each adsorbent to be evaluated to 10 ml aliquots of a solution of 80 ppm Pd added as PdCl₂(P(phenyl)₃)₂ (Sigma) in 50:50 dimethylformamide:tetrahydrofuran, along with quinine added at a concentration of 20 mg/ml. The samples were mixed on an orbital shaker at 50 rpm for 24 hours, and then filtered using a 0.22 micrometer PTFE syringe filter. Each sample was run in duplicate. The residual Pd in solution was measured by inductively coupled plasma. The results are illustrated in FIG. 9. It may be seen that adsorbents 1B, 1D and 1E of Example 1 are comparable to Control A and B.

### Example 8—Measurement of Adsorbent Affinity for Cu

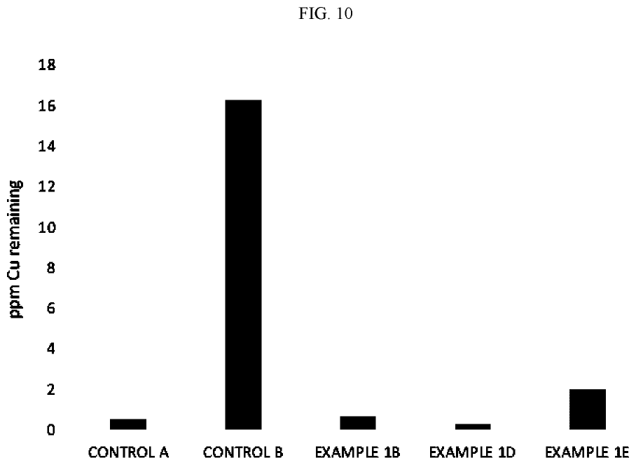

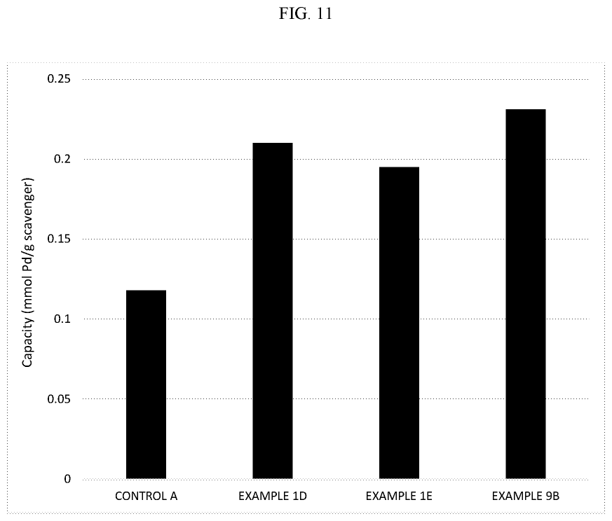

Samples were prepared by adding 80 mg of each adsorbent to be evaluated to 10 ml aliquots of a solution of 100 ppm Cu added as CuI (Sigma) in acetonitrile. The samples were mixed on an orbital shaker at 50 rpm for 24 hours, and then filtered using a 0.22 micrometer PTFE syringe filter. Each sample was run in triplicate. The residual Cu in solution was measured by inductively coupled plasma. The results are illustrated in FIG. 10. It may be seen that the adsorbents 1B, 1D, and 1E of Example 1 are comparable to or better than Control A and Control B.

In another aspect of the disclosure, Applicants have developed adsorbents comprising particles of polymer functionalized with at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing, and wherein the polymer is a swellable polymer. In some embodiments the swellable polymer can be based on polystyrene, which optionally may include other monomers. In one embodiment the adsorbent particles having at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing have an average particle size measured on a non-solvated basis in the range of about 100-300 microns, or in the range of 125-250 microns. In one embodiment the adsorbent particles having at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing have an average particle size measured on a non-solvated basis of less than 150 microns.

Applicants have found that, unexpectedly, adsorbents comprising a swellable polystyrene polymer functionalized with a 2,4,6,-trimercaptotriazine-ethylenedithiol (TMT-EDT) adduct or 2,4,6,-dimercaptotriazine-ethylenedithiol (DMT-EDT) adduct have excellent adsorption capacity.

### Example 9—Functionalization of Polystyrene with Dimercaptotriazine Ethanediol

A. Functionalization of polystyrene with DCT. In a 1-L Pyrex jar, cyanuric chloride (46.8 g, 254 mmol) was dissolved in THF (500 ml). The solution was cooled to 5° C. in an ice bath and DIPEA (27.7 ml, 159 mmol) was added. PS—NH₂ (65.0 g, 1% crosslinked, —127 mmol —CH₂NH₂) was added in about 10 g portions. The reaction exothermed strongly. The reaction was monitored with a ninhydrin test. After about 4 hours the resulting functionalized polystyrene product was washed with THF twice, then soaked in THF overnight and dried by rotary evaporation to yield 102 g of product. By elemental analysis the product had 5.02 mmol/g N and 2.61 mmol/g Cl.

B. Conversion of functionalized DCT to DMT-EDT. In a 500-mL Pyrex jar, ethane dithiol (6.7 ml, 80 mmol) was dissolved in DMF (200 ml). The solution was cooled using an ice bath. 60% suspension of NaH in mineral oil (3.20 g, 80 mmol) was then added in about four portions. The thiolate solution was allowed to warm to room temperature, then the PS-DCT product of step A (20 g) was added. The reaction was placed in a 100° C. oven overnight. The resulting PS-DMT-EDT product was filtered while warm and washed with DMF 2×, 1M HCl, DMF 2×, water 2×, THF 2×, THF (overnight soak), THF 3×, MeOH (this causes the polymer to shrink and makes it much easier to dry) and then dried by rotary evaporation to yield 18.2 g of product. By elemental analysis the product had 4.27 mmol/g N and 2.91 mmol/g S.

### Example 10 Measurement of Adsorbent Capacity for Pd

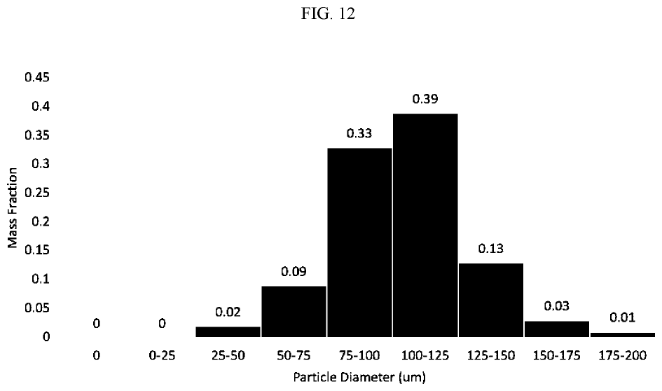

Samples were prepared by adding 40 mg of each adsorbent to be evaluated to 20 ml aliquots of a solution of 170 ppm Pd added as PdCl₂(P(phenyl)₃)₂ (Oakwood) in 50:50 dimethylformamide:tetrahydrofuran. The samples were mixed on an orbital shaker at 50 rpm for 24 hours, then filtered using a 0.22 micrometer PTFE syringe filter. Each sample was run in triplicate. The residual Pd in solution was measured by ICP spectrophotometry. The adsorbents evaluated were absorbents prepared in example 9B, 1D, 1E, and a commercially available adsorbent comprising DMT on a silica support (Control A). The results are illustrated in FIG. 11. It may be seen that the adsorbent of Example 9B has a palladium capacity higher than Control A.

### Example 11 Larger Scale Preparation of Adsorbent V with Particle Size Measurements

The adsorbent shown in structure V of Scheme 1 was prepared using substantially the same processes of Example 1 steps A, B, C and E, but on a 10 liter scale. The resulting particles were analyzed by scanning electron microscopy (SEM) and found to have an average particle size of 95.2±31 microns. To determine particle size distribution, a small sample of the adsorbent was applied to a black double-sided tape attached to the SEM sample plate. The sample was then placed into the SEM under vacuum and inspected under 37× magnification. The length of each particle was manually measured using the Ruler tool provided by the SEM software. The number of particles in every 25 μm size range was tabulated from 0 μm to 200 μm. The results are presented in FIG. 12.

What is claimed is:

1. A process for reducing the concentration of at least one contaminant in a liquid composition comprising the at least one contaminant, the process comprising:
contacting said liquid composition with an adsorbent at purification conditions to adsorb at least a portion of the at least one contaminant; wherein the adsorbent comprises particles of macroreticular polymer functionalized with at least one functional moiety capable of binding one or more contaminants, the adsorbent having a pore volume of at least 0.65 cm³/g.

2. The process of claim 1 wherein said liquid composition is a composition in the process for the manufacture of an active pharmaceutical ingredient.

3. The process of claim 1 wherein said liquid composition comprises an active pharmaceutical ingredient or a precursor thereof.

4. The process of claim 1 wherein said at least one contaminant is an elemental impurity selected from at least one element from class 1, class 2 Å, class 2B, and class 3 of the ICH Q3D(R1) guidelines.

5. The process of claim 4 where the adsorbent binds a quantity of the elemental impurity in the liquid composition to provide a liquid composition having a concentration of the elemental impurity which calculates to a concentration of the elemental impurity in a recovered API which is at or below its Permitted Daily Exposure (PDE).

6. The process of claim 1, wherein said the at least one functional moiety is a compound selected from cysteamine, 2,4,6,-trimercaptotriazine (TMT), 2,4,6,-dimercaptotriazine (DMT), 2,4,6,-dimercaptotriazine-ethanedithiol (DMT-EDT) adduct, 2,4,6,-trimercaptotriazine-ethanedithiol (TMT-EDT) adduct, thioglycolic acid (TGA), thiourea, 4-mercapto pyridine, 1,4,7,10-Tetraazacyclododecane-1,4,7,10-tetraacetic acid (DOTA), ethylenediaminetetraacetic acid (EDTA), thiosulfate (TS), mercaptomethyl phosphonic acid (MPA), trimercaptotriazine-methyl-phosphonic acid (TMT-PA), and mixtures of any of the foregoing.

7. The process of claim 1, wherein said functionalized macroreticular polymer adsorbent particles have a particle size distribution D90 ranging from about 50-150 microns.

8. The process of claim 1, wherein said adsorbent particles have an average particle size of less than 150 microns.

9. An adsorbent comprising particles of macroreticular polymer functionalized with at least one functional moiety capable of binding one or more contaminants, the adsorbent particles having a pore volume of at least 0.65 cm³/g.

10. The adsorbent of claim 9, wherein said macroreticular polymer has an average pore size of 69 Å to 110 Å.

11. The adsorbent of claim 9, wherein the adsorbent particles have a pore size distribution wherein D50 is less than 200 Å.

12. The adsorbent of claim 9 wherein said at least one functional moiety is selected from cysteamine, 2,4,6,-trimercaptotriazine (TMT), 2,4,6,-dimercaptotriazine (DMT), 2,4,6,-dimercaptotriazine-ethanedithiol (DMT-EDT) adduct, 2,4,6,-trimercaptotriazine-ethanedithiol (TMT-EDT) adduct, thioglycolic acid (TGA), thiourea, 4-mercapto pyridine, 1,4,7,10-Tetraazacyclododecane-1,4,7,10-tetraacetic acid (DOTA), ethylenediaminetetraacetic acid (EDTA), thiosulfate (TS), mercaptomethyl phosphonic acid (MPA), trimercaptotriazine-methyl-phosphonic acid (TMT-PA), and mixtures of any of the foregoing.

13. The adsorbent of claim 9 wherein said functionalized macroreticular polymer adsorbent particles have a particle size distribution D90 ranging from about 50-150 microns.

14. A method of functionalizing a polymer comprising alkene groups, said method comprising the steps of
a.) reacting said polymer with a first reactant comprising a thiol group and a linking group, whereby a first reactant thiol group reacts with a polymer alkene group in a thiol-ene reaction to form a thioether linkage between said polymer and said linking group,
b.) reacting the product of step a. with a second reactant comprising an aryl or heteroaryl group, wherein said aryl group or heteroaryl group is substituted or unsubstituted, to bind the second reactant to the linking group, and
c.) reacting the product of step b. with a third reactant having a functional moiety, wherein said third reactant binds to said second reactant to link said functional moiety thereto, thereby functionalizing said polymer with said functional moiety.

15. The method of claim 14 wherein said functional moiety linked to said triazine group by the reaction of step c) comprises a thiol group.

16. The method of claim 14 wherein said third reactant is selected from a sulfide salt and a polythiolated alkane.

17. An adsorbent comprising particles of a polymer functionalized with at least one functional moiety selected from 2,4,6,-dimercaptotriazine-ethanedithiol (DMT-EDT) adduct, 2,4,6,-trimercaptotriazine-ethanedithiol (TMT-EDT) adduct, or a combination thereof, wherein said polymer is selected from a swellable polymer and a macroreticular polymer.

18. The adsorbent of claim 17 wherein said polymer is a macroreticular polymer.

19. The adsorbent of claim 17 wherein said polymer is a swellable polymer.

20. A process for reducing the concentration of at least one contaminant in a liquid composition comprising the at least one contaminant, the process comprising:
contacting said liquid composition with an adsorbent at purification conditions to adsorb at least a portion of the at least one contaminant; wherein the adsorbent comprises particles of polymer functionalized with at least one functional moiety selected from 2,4,6,-dimercaptotriazine-ethanedithiol (DMT-EDT) adduct, 2,4,6,-trimercaptotriazine-ethanedithiol (TMT-EDT) adduct, and mixtures of any of the foregoing, and wherein the polymer is selected from a swellable polymer and a macroreticular polymer.

21. The process of claim 20 wherein the polymer is a macroreticular polymer.
